(19) United States
(12) Patent Application Publication
(10) Pub. No.: US 2007/0057928 A1
(43) Pub. Date: Mar. 15, 2007

(54) Input device for a vehicle

(76) Inventors: Michael Prados, San Francisco, CA (US); Brian Finn, East Palo Alto, CA (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/531,132

(22) Filed: Sep. 12, 2006

Related U.S. Application Data
(60) Provisional application No. 60/717,088, filed on Sep. 14, 2005.

(51) Int. Cl. G09G 5/00

(52) U.S. Cl. 345/173

(57) ABSTRACT

An input device, especially for a vehicle, has a housing, a display arranged in the housing for optical display of information, a touchscreen arranged above the display for input of commands by touching an operating surface of the touchscreen and an actuator to move the touchscreen and housing in at least one direction, and in which the housing is movable relative to the display.

### CROSS-REFERENCE TO RELATED APPLICATIONS

This application claims the benefit of U.S. Provisional Application No. 60/717,088 filed on Sep. 14, 2005, entitled “EINGABEVORRICHTUNG FUR EIN KRAFTFAHRZEUG”.

### TECHNICAL FIELD

The invention concerns an input device, especially for a vehicle, with a touchscreen.

### BACKGROUND

A touchscreen is known from DE 201 02 197 U1 (incorporated by reference). A touchscreen is disclosed in DE 201 02 197 U1 for display of electronic signals and a confirming touch input of characters and symbols, consisting of a functional plane for display and a key input, and a superordinate, point-deformable protective plane corresponding to it. During selection of certain points of the functional plane by touching above the protective plane, at least one confirmation signal for the sense of touch (haptic stimulation) of the user, detectable at the position of the touching point in the deformed protective plane, is generated and the confirmation signal for the sense of touch (haptic stimulation) is generated by vibrating elements arranged eccentrically within and/or beneath the functional level. In addition, in the touchscreen known from DE 201 02 197 U1, the generated vibrations are transferred from the functional level to the protective level by direct contact of the two levels and/or via the edge regions of the levels by rigid or elastic connection elements.

Touchscreens are also known, for example, from U.S. Pat. No. 4,885,565 and EP 920 704 B1. Appropriate touchscreens are available, for example, touchscreens from 3M™ (see www.3m.com). Additional details concerning touchscreens can be taken from EP 1 560 102 A1.

A touch control with haptic feedback to enter signals into a computer and for output of forces to a user of the touch control is known from DE 201 80 024 U1 and the corresponding WO 01/54109 A1 (incorporated by reference) for haptic feedback, in which the touch control has a touch input device, which has a roughly flat contact surface, operated so that based on a position on the contact surface that a user touches, a position signal is entered in a processor of the computer, the position signal displaying the position in two dimensions. The touch control according to WO 01/54109 A1 also has at least one actuator connected to the touch input device, in which the actuator exerts a force on the touch input device, in order to deliver a haptic sensation to the user touching the contact surface, in which the actuator sends the force directly to the touch input device based on force information output from the processor.

Haptic feedback is also known from U.S. Pat. No. 6,429,846, WO 03/038800 A1 (incorporated by reference), U.S. Pat. No. 5,988,902, WO 99/26230 A1 (incorporated by reference), WO 97/21160 a1 (incorporated by reference), DE 200 22 244 U1 (incorporated by reference) and WO 03/41046A1 (incorporated by reference).

U.S. Pat. No. 6,118,435 discloses a touch panel.

An operating element for a device with several selectable menus, functions and/or function values is known from DE 197 31 285 A1, which has a surface that can be grasped by the user, and via which the selection can be made by a local movement or touching of the surface. The surface is variable in configuration according to the selected and/or selectable menu, function and/or function value.

The task of the invention is to improve an input device with a touchscreen. It is desirable to create an input device that is particularly suited for vehicles. Such an input device is characterized, in particular, by a long lifetime with relatively low cost.

### SUMMARY

The aforementioned task is solved by an input device, especially for a vehicle, in which the input device includes a housing, a display arranged in the housing for optical display of information, a touchscreen arranged above the display for input of commands by touching an operating surface of the touchscreen and an actuator to move the touchscreen or housing in at least one direction, in which the housing can be moved relative to the display. It is then prescribed, in particular, that the display be fastened to a reference element, for example, a steering wheel or a dashboard.

A touchscreen according to the invention is especially a transparent touchscreen. A display according to the invention is especially a display or matrix display for a variable display of information. A display according to the invention can be a TFT.

In one embodiment of the invention, the touchscreen is fastened to the housing, especially on the outside.

In another embodiment of the invention, the housing includes a transparent region.

In another embodiment of the invention, the housing is transparent (at least) in the region of the touchscreen.

In another embodiment of the invention, the touchscreen is part of the housing.

In another embodiment of the invention, the touchscreen or the housing is moveable by means of the actuator relative to the display, especially only along a line. The touchscreen or the housing, in another embodiment of the invention, is then movable parallel to an operating surface of the touchscreen. In another embodiment of the invention, the touchscreen or housing is movable relative to the display only with one degree of freedom.

In another embodiment of the invention, a connection element is provided for shape-mated connection of the housing to the display, so that the housing can be moved relative to display only along a line. The connection element then includes, in another embodiment of the invention, a rod or guide element. The housing and the display are then movable, in particular, along the rod relative to each other, parallel to an operating surface of the touchscreen.

In another embodiment of the invention, the housing has at least one opening, covered by a flexible sleeve. It is then prescribed, in particular, that the display has an operating element guided through the opening for fixation of the display.

The aforementioned task is also solved by an input device, especially for a vehicle, in which the input device includes a housing, a display arranged in the housing for optical display of information, and a touchscreen arranged above the display for input of commands by touching an operating surface of the touchscreen, in which the display is movable only along a line in the housing.

In another embodiment of the invention, a connection element is provided for shape-mated connection of the housing to the display, so that the housing can only be moved relative to the display along a straight line. The connection element then includes, in another embodiment of the invention, a rod or a guide element. The housing and the display are then movable, in particular, along the rod or guide element relative to each other, parallel to an operating surface of the touchscreen.

In another embodiment of the invention, the touchscreen is fastened to the housing, especially on the outside.

In another embodiment of the invention, the housing includes a transparent region.

In another embodiment of the invention, the housing is transparent (at least) in the region of the touchscreen.

In another embodiment of the invention, the touchscreen is part of the housing.

In another embodiment of the invention, the housing has at least one opening, covered by a flexible sleeve. It is then prescribed, in particular, that the display has a fastening element guided through the opening for fastening of the display.

The aforementioned task is additionally solved by an input device, especially for a vehicle, in which the input device includes a housing, a display arranged in the housing for optical display of information, a touchscreen arranged above the display for input of commands by touching an operating surface of the touchscreen, at least two guide elements arranged parallel to each other and at least two slide elements for sliding along a guide element.

The aforementioned task is additional solved by a vehicle, which includes a steering wheel, a dashboard, a housing, a display arranged in the housing for optical display of information, a touchscreen arranged above the display for input of commands by touching an operating surface of the touchscreen and an actuator to move the touchscreen or the housing in at least one direction, in which the housing is movable relative to the display, and in which the display is fastened relative to the steering wheel or relative to the dashboard.

In another embodiment of the invention, the actuator is connected to the steering wheel or dashboard.

In another embodiment of the invention, the housing includes a transparent region.

In another embodiment of the invention, the housing is transparent (at least) in the region of the touchscreen.

In another embodiment of the invention, the touchscreen is part of the housing.

In another embodiment of the invention, the touchscreen of the housing is movable by means of the actuator relative to the display, especially only along a straight line. The touchscreen of the housing, in another embodiment of the invention, is then movable parallel to an operating surface of the touchscreen. In another embodiment of the invention, the touchscreen of the housing is movable relative to the display only with one degree of freedom.

In another embodiment of the invention, a connection element for shape-mated connection of the housing is provided to the display, so that the housing is movable relative to the display only along a straight line. The connection element, in another embodiment of the invention, then includes a rod or a guide element. The housing and display are then movable along the rod relative to each other, parallel to an operating surface of the touchscreen.

In another embodiment of the invention, the housing has at least one opening covered by a flexible sleeve. Then it is prescribed, in particular, that the display have a fastening element guided through the opening for fastening of the display to the steering wheel or the dashboard.

The aforementioned task is additionally solved by an input device, especially for a vehicle, in which the input device includes a display for optical display of information, a transparent touchscreen arranged above the display for input of commands by touching the operating surface of a touchscreen, a flexible element arranged between the display and the touchscreen to prevent penetration of particles between the display and the touchscreen and an actuator to move the touchscreen relative to display in at least one direction, especially parallel to the operating surface of the touchscreen, in which the flexible element has a rigidity that is adjusted to a weight of the touchscreen, so that the touchscreen, in conjunction with the flexible element, has a mechanical, natural frequency between 5 Hz and 150 Hz. A display, in this sense, can also include a housing, in which a display is arranged.

In another embodiment of the invention, the flexible element is arranged on the edge of the touchscreen, so that it essentially does not cover a display surface of the display.

In another embodiment of the invention, the flexible element is configured as a continuous seal or part of a continuous seal to seal a gap between the touchscreen and the display.

The aforementioned task is additionally solved by an input device, especially for a vehicle, in which the input device includes a display for optical display of information, a touchscreen arranged above the display for input of commands by touching an operating surface of the touchscreen, a flexible element arranged between the display and the touchscreen to prevent penetration of particles between the display and the touchscreen and an actuator to move the touchscreen relative to the display in at least one direction, especially parallel to the operating surface of the touchscreen. A display in this sense can also include a housing, in which display is arranged.

In another embodiment of the invention, the flexible element is arranged on the edge of the touchscreen, so that it essentially does not cover the display surface of the display.

In another embodiment of the invention, the flexible element has a rigidity that is adjusted to a weight of the touchscreen, so that the touchscreen, in conjunction with the flexible element, has a mechanical natural frequency between 5 Hz and 150 Hz.

In another embodiment of the invention, the flexible element comprises polyurethane or consists essentially of polyurethane.

In another embodiment of the invention, the flexible element is configured as a continuous seal or part of a continuous seal to seal a gap between the touchscreen and the display.

The aforementioned task is additionally solved by an input device, especially for a vehicle, in which the input device includes a display for optical display of information, a touchscreen arranged above the display for input of the commands by touching an operating surface of the touchscreen, a flexible element arranged between the display and the touchscreen with at least one pair of grooves that extend essentially linearly and intersect, and an actuator to move the touchscreen relative to the display in at least one direction, especially parallel to the operating surface of the touchscreen. The display, in this sense, can also include a housing, in which a display is arranged.

In another embodiment of the invention, the grooves are sloped relative to the operating surface of the touchscreen between about 30° and about 60°, especially about 45°.

In another embodiment of the invention, at least two grooves have a common intersection site, configured as a spherically bulged dome.

In another embodiment of the invention, a transition between a groove and a flat surface has a radius of curvature that is three to five times the thickness of a material, from which the groove is formed.

In another embodiment of the invention, the flexible element is configured to prevent penetration of particles between the display and the touchscreen.

In another embodiment of the invention, the flexible element has a rigidity that is adjusted to the weight of the touchscreen, so that the touchscreen, in conjunction with the flexible element, has a mechanical natural frequency between 5 Hz and 150 Hz.

In another embodiment of the invention, the flexible element is arranged on the edge of the touchscreen, so that it essentially does not cover the display surface of the display.

In another embodiment of the invention, the flexible element is configured as a continuous seal or as part of a continuous seal to seal a gap between the touchscreen and the display.

In another embodiment of the invention, the flexible element includes an elastomer or consists essentially of an elastomer.

In another embodiment of the invention, the flexible element includes a folded or protruding region, perpendicular to the direction of movement.

The weight of the touchscreen, according to the invention, is supposed to also include the weight of a rigid element firmly connected to the touchscreen. The particles according to the invention include a particular dust particle.

The vehicle according to the invention is especially a land vehicle, usable individually in traffic. The vehicles according to the invention are not particularly restricted to land vehicles with an internal combustion engine.

Touching of the touchscreen according to the invention can also or only be pressing on a touchscreen.

Further advantages and details are apparent from the following description of the practical examples.

### BRIEF DESCRIPTION OF THE DRAWINGS

FIG. 1 shows a practical example for a cockpit of a vehicle;

FIG. 2 shows a practical example of an input device with corresponding control in a sketch;

FIG. 3 shows the input device according to FIG. 2 in a perspective top view;

FIG. 4 shows the input device according to FIG. 2 in cross-section;

FIG. 5 shows the input device according to FIG. 2 from below;

FIG. 6 shows a modified configuration of the input device according to FIG. 2 in a cross-section;

FIG. 7 shows another modified embodiment of the input device according to FIG. 2 in a cross-section;

FIG. 8 shows the input device according to FIG. 5 in a perspective view from below;

FIG. 9 shows another modified embodiment of the input device according to FIG. 2 in an exploded view;

FIG. 10 shows another practical example of an input device in a perspective top view;

FIG. 11 shows a practical example of a folded or protruding region;

FIG. 12 shows another practical example of a folded or protruding region;

FIG. 13 shows another practical example of a folded or protruding region;

FIG. 14 shows another practical example of an input device in a perspective top view;

FIG. 15 shows a practical example of a deflection of a touchscreen;

FIG. 16 shows another practical example of a deflection of a touchscreen; and

FIG. 17 shows another practical example of a deflection of a touchscreen.

### DETAILED DESCRIPTION

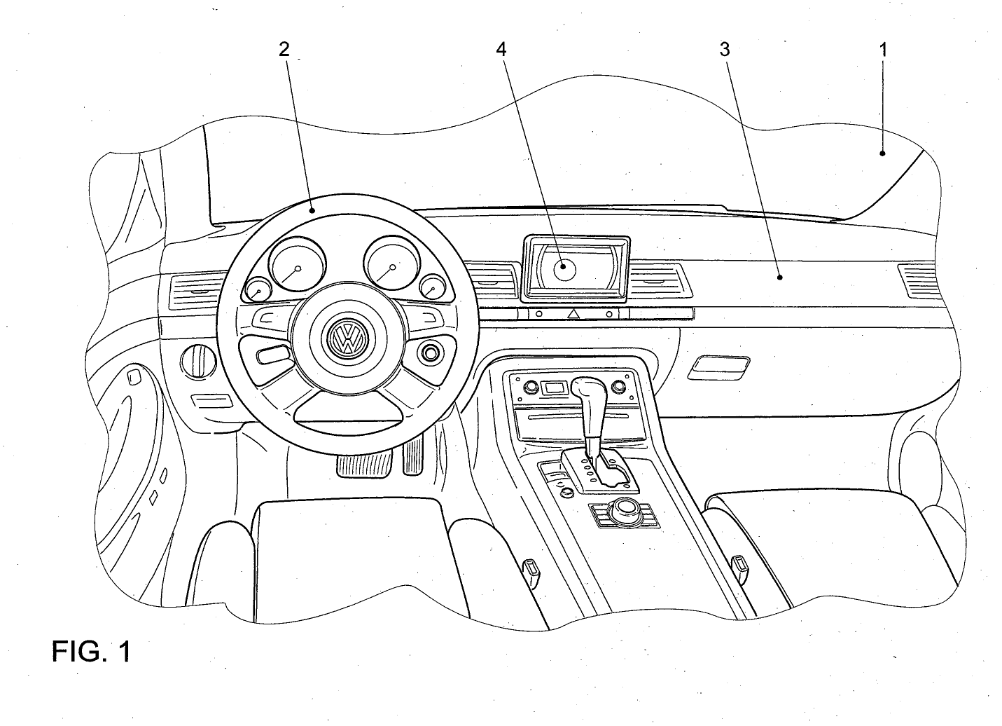

FIG. 1 shows a practical example for a cockpit of a vehicle 1. A steering wheel 2 is arranged in the cockpit 1 beneath a dashboard 3. A dashboard 3 has an input device 4 arranged next to the steering wheel 2. As an alternative or in addition, an input device corresponding to input device 4 can also be arranged in the steering wheel 2.

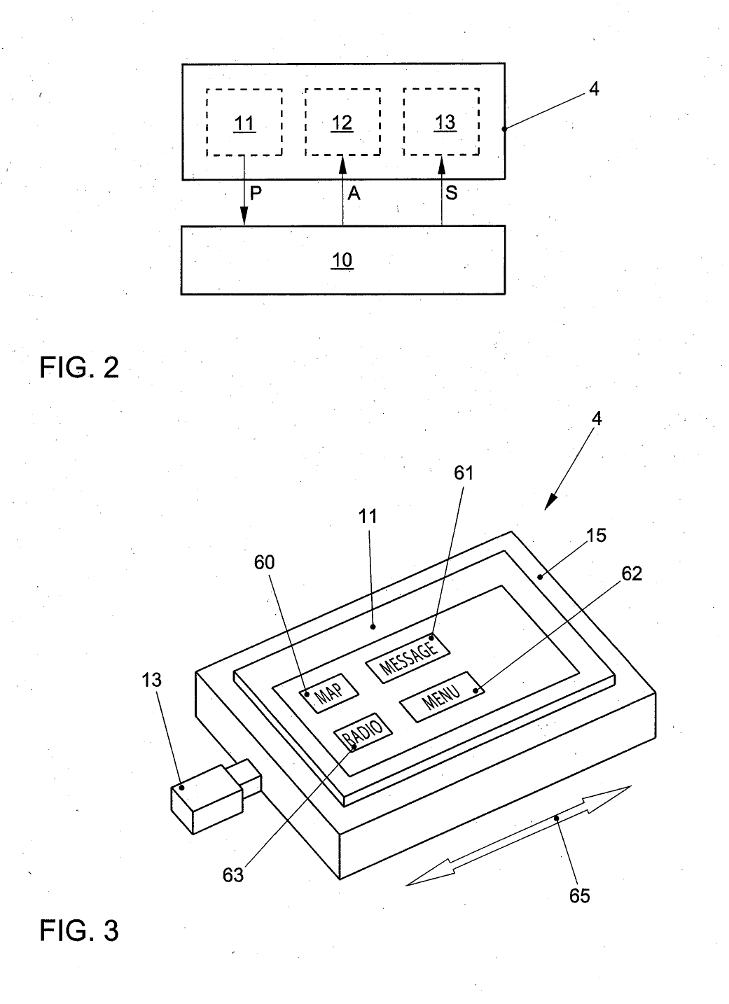

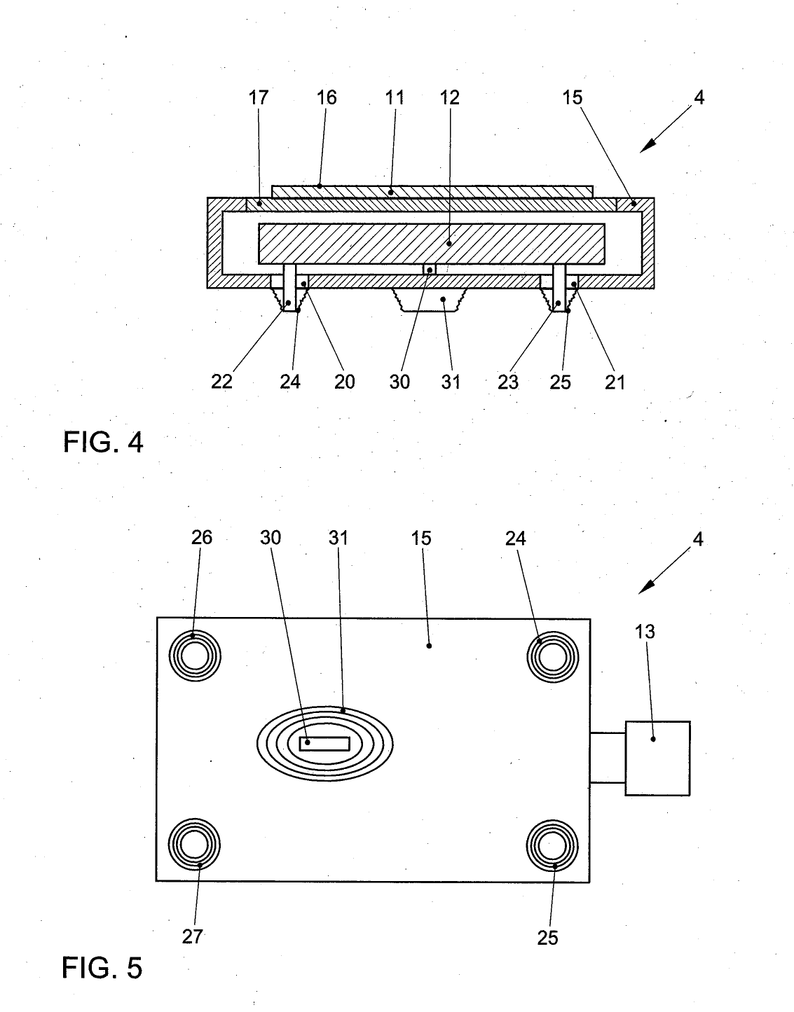

FIG. 2 shows the input device 4 with a connective control in a sketch. FIG. 3 shows the input device 4 in a perspective top view. FIG. 4 shows the input device 4 in a cross section. FIG. 5 shows the input device 4 from below. The input device 4 includes a housing 15, a display 12 arranged in the housing 15 for optical display of information, as, for example, the operating elements designated with reference numbers 60, 61, 62 and 63 in FIG. 3, a touchscreen 11 arranged above the display 12 and connected to the housing for input of commands by touching operating surface 16 of touchscreen 11 and an actuator 13 to move the housing 15, and therefore touchscreen 11 relative to display 12, in the direction of the double arrow 65. The input device 4 is connected to a control 12, by means of which different information can be displayed on display 12 by output of a corresponding display signal A. In addition, the control 10 enters a position signal P produced from the touchscreen 11, which gives the position of touching of the operating surface 16 or pressing on the operating surface 16. In addition, the control 10 controls movement of the actuator 13 by producing and actual control signal S. One embodiment of actuator 13 can be taken from EP 1 560 102 A1. Moreover, piezo-actuators or so-called voice coils can be used as actuator 13.

The touchscreen 11 is fastened to housing 15 on the outside. Housing 15 is then transparent, at least in the region beneath touchscreen 11, denoted with reference number 17. As an alternative, touchscreen 11 can also be configured as part of housing 15.

The housing 15 includes, as shown in FIGS. 4 and 5, four openings 20 and 21 covered by a flexible sleeve 24, 25, 26 and 27, through which fastening elements 22 and 23 for fastening of display 12 to steering wheel 2 or dashboard 3 are guided. Housing 15 also includes an additional opening covered by an additional flexible sleeve 31, through which a plug contact 30 for power supply of display 12 and for transmission of the display signal A to display 12 is guided. The flexible sleeves 24, 25, 26, 27 and 31 can consist of an elastomer or include an elastomer. It is prescribed, in particular, that the flexibility of sleeves 24, 25, 26, 27 and 31 is adjusted to the weight of housing 15, including touchscreen 11, so that the housing 15 (including touchscreen 11), in conjunction with sleeves 24, 25, 26, 27 and 31, has a mechanical natural frequency between 5 Hz and 150 Hz. The natural frequency is adjusted to the actuator 13 and the actuator chosen according to the natural frequency.

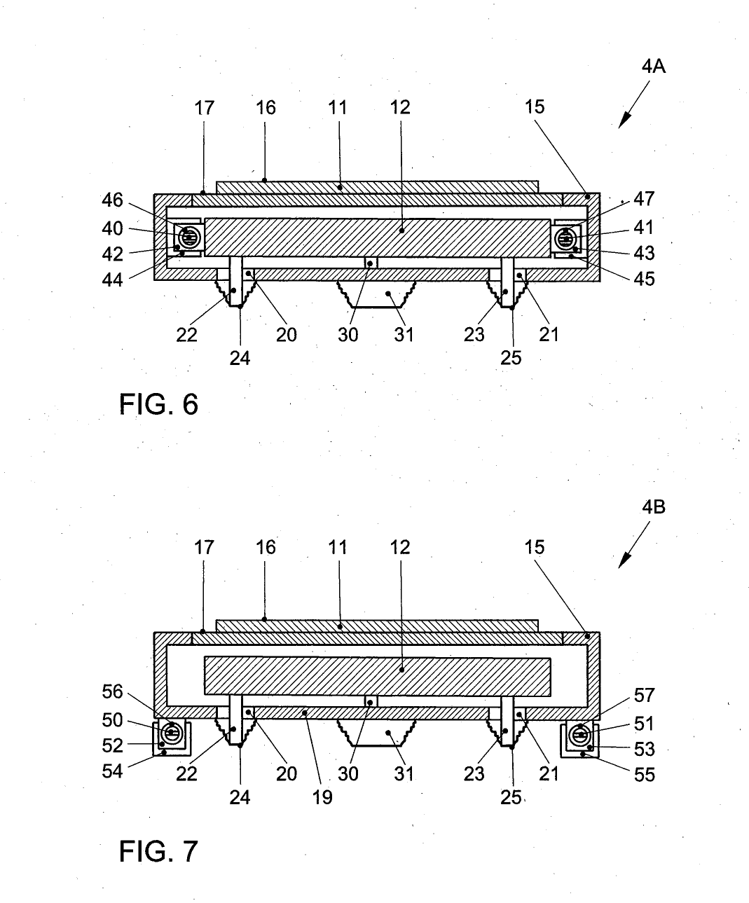

FIG. 6 shows an input device 4A, modified relative to the input device 4, in a cross-section, in which the same reference numbers as in FIG. 2, FIG. 3, FIG. 4 and FIG. 5 denote the same or equivalent elements. The input device 4A includes connection elements for shape-mated connection of housing 15 to display 12, so that the housing 15 can be moved relative to display 12 only along a straight line. For this purpose, a connection element includes at least one fastening element 44 or 45 connected to the housing 15 for fastening of a rod 40 or 41. In addition, the connection element includes at least one sliding element 42 or 43 connected to display 12 with at least one sliding bearing 46 or 47, by means of which the sliding element 42 or 43 can be moved along rod 40 or 41. It can also be prescribed that the sliding element 42 or 43 be (firmly) connected to housing 15 and fastening element 44 and 45 to display 12.

FIG. 7 shows another input device 4B, modified relative to the input device 4, in a cross section, in which the same reference numbers as in FIG. 2, FIG. 3, FIG. 4 and FIG. 5 denote the same or equivalent elements. The input device 4B includes connection elements for shape-mated connection of housing 15 to display 12, so that the housing 15 can be moved, relative to display 12, only along a straight line. For this purpose, a connection element includes at least one fastening element 54 or 55, connected or connectable to steering wheel 2 or dashboard 3, for fastening of a rod 50 or 51. In addition, a connection element includes a sliding element 52 or 53, connected to the housing 15 or a lower part 19 of housing 15, each with at least one sliding bearing 56 or 57, by means of which the sliding element 52 or 53 can be moved along 50 or 51. It can also be prescribed that the sliding element 52 or 53 be connected or connectable to the steering wheel 2 or dashboard 3, and that the fastening element 54 or 55 be (firmly) connected to housing 15. The moving connection between display 12 and housing 15 can then occur via steering wheel 2 or dashboard 3 or via an additional element. For example, both the sliding elements 52 and 53 and the fastening element 54 and 55 can be fastened to a frame. This frame can again be connected to the steering wheel 2 or dashboard 3 for incorporation in the vehicle 1.

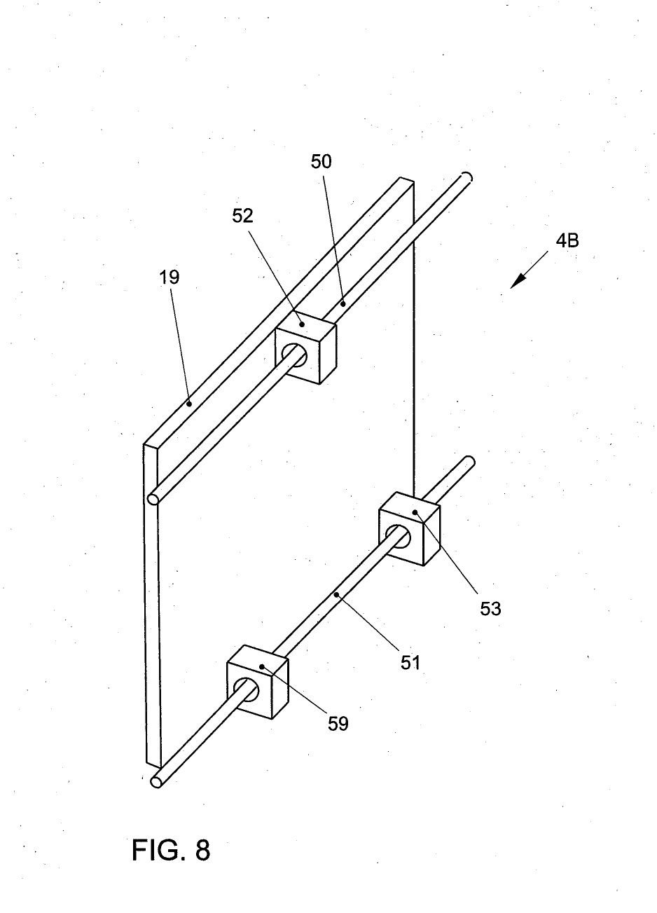

FIG. 8 shows, in a simplified view, a cutout of the input device 4B in a perspective view from below. Reference number 59 then denotes a sliding element corresponding to sliding elements 52 and 53. Advantageously, no more than three sliding elements are provided. The sleeves 24, 25, 26, 27 and 31 are not shown, for reasons of clarity in FIG. 8.

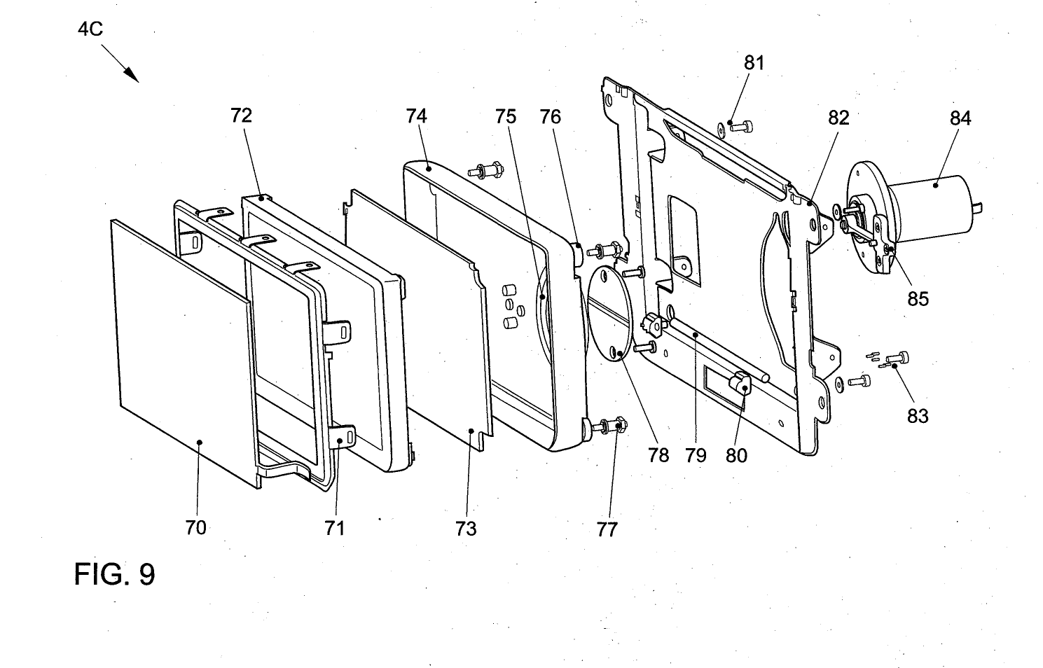

FIG. 9 shows another input device 4C, modified relative to the input device 4, in an exploded view (incomplete, for reasons of clarity). The input device 4C includes a touchscreen 70, corresponding to touchscreen 11, and a mount 71 for touchscreen 70. The input device 4C also includes a display 72, corresponding to display 12, as well as a control circuit board 73 connected to display 72. The input device 4C also includes a support 74 with a control circuit board 75 connected to touchscreen 70. The touchscreen 70, mount 71 and support 74 form a housing corresponding to housing 15.

The support 74 includes flexible sleeves or seals 76, through which pins 77 for fastening of display 72 to a frame 82 are inserted, in which the pins 77 are fastened with screws 81 to frame 82. The input device 4C also includes an interface board 78 for data connection of the input device 4C to control 10 or a control corresponding to control 10. The input device 4C also includes a fastening element 80 that can be fastened by means of a screw 83 to frame 82 for fastening of a rod 79. The support 74 includes on its back (not apparent in FIG. 9) connection elements for shape-mated connection of support 74 to frame 82, so that the support 74 can be moved relative to frame 82 along rod 79. In this embodiment, the housing and the display 72 are also connected to each other in shape-mated fashion according to the invention, so that the housing can be moved relative to display 72 only along a straight line.

The input device 4C also includes an actuator 84 corresponding to actuator 13, which can correspond to an eccentric 85, which corresponds to the eccentric of the actuator depicted in EP 1 560 102 A1.

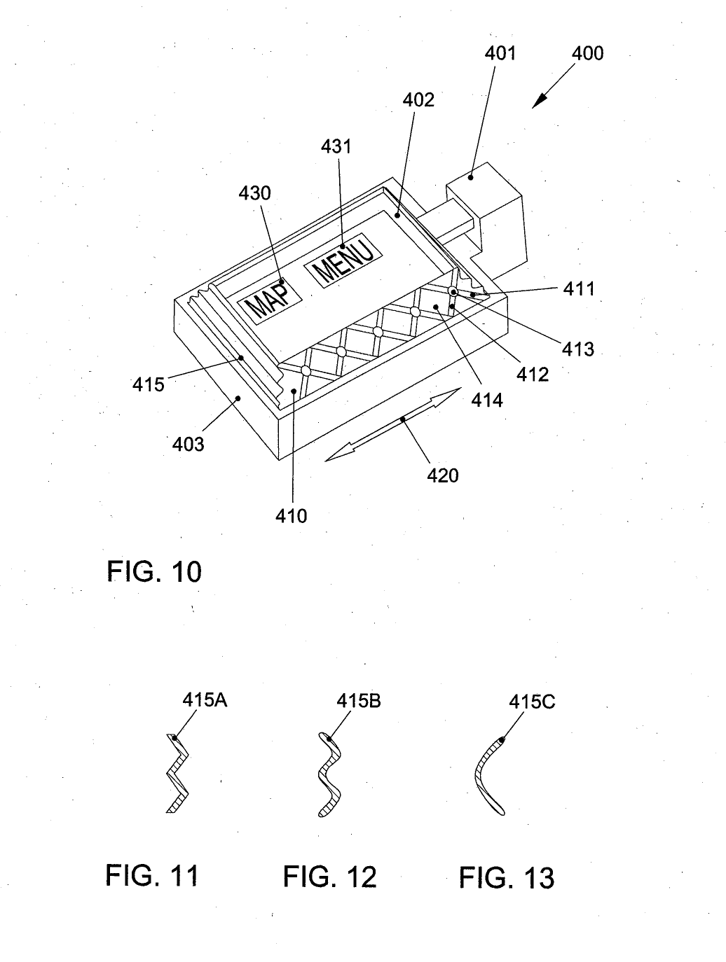

FIG. 10 shows another practical example of an input device 400 for use instead of input device 4 in a vehicle 1 in a perspective top view. The input device 400 includes a display 403, optionally arranged in a housing for optical display of information, like the operating elements designated with reference numbers 430 and 431 in FIG. 10, a touchscreen 402 arranged above display 403 and connected to the display 403 (or its housing) for entry of commands by touching the operating surface of the touchscreen 402, and an actuator 401 for movement of the touchscreen 402 relative to the display 403. A gap is provided between the touchscreen 402 and the display 403, so that the touchscreen 402 can be moved relative to the display 403 without mechanical surface wear. The input device 400 is connected to a control (not shown) corresponding to control 10. The touchscreen 402 can include a transparent support, including a touchscreen in the narrow sense, which is arranged on the support.

A flexible element 410 for prevention of penetration of dust particles (into the gap) between display 403 and the touchscreen 402 is arranged between display 403 and touchscreen 402. For this purpose, the flexible element 410 is arranged continuously on the edge of touchscreen 402. The flexible element 410 has a rigidity adjusted to the weight of the touchscreen 402, so that the touchscreen 402, in connection with the flexible element 410, has a mechanical natural frequency between 5 Hz and 150 Hz in the movement direction (i.e., in the present practical example, in the direction of double arrow 420).

The flexible element 410 consists essentially of an elastomer and includes—at least in the movement direction (i.e., in the present practical example, in the direction of double arrow 420)—essentially linearly extending grooves 411 and 412 that interest in pairs, so that two grooves 411 and 412 have a common intersection point 413, configured as a spherically bulged dome. The grooves 411 and 412 are sloped roughly 45° relative to the operating surface of touchscreen 402. The transition between groove 411 or 412 in a flat region 14 has a radius of curvature that amounts to three to five times the thickness of a material, from which the groove 411 or 412 is formed. Appropriate embodiments for a region of the flexible element 410 configured in this way can be taken from U.S. Pat. No. 4,044,186 (incorporated by reference), as well as the corresponding DE 2 349 499 (incorporated by reference).

Flexible element 410 includes a folded or protruding region 415, perpendicular to the direction of movement (i.e., in the practical example, perpendicular to direction of double arrow 420). Additional practical examples of a folded or protruding region 415A 415B and 415C are shown in FIG. 11, FIG. 12 and FIG. 13.

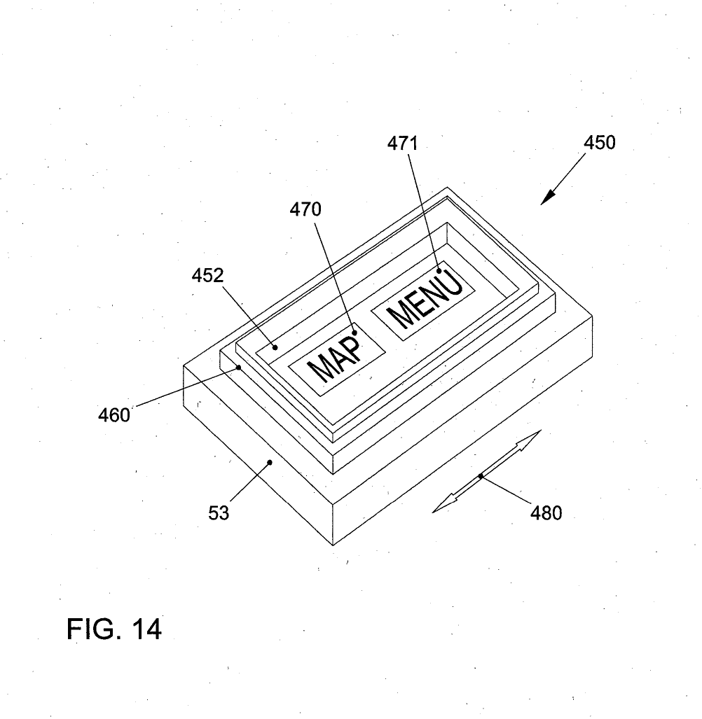

FIG. 14 shows another practical example of an input device 450 for use in ??? input device 4 in a perspective top view. Input device 450 includes a display 453, arranged optionally in a housing, for optical display of information, for example, the operating elements designated with reference numbers 470 and 471 in FIG. 14, a touchscreen 452 arranged above display 453 and connected to display 453 (or its housing) for input of commands by touching an operating surface of the touchscreen 452, and an actuator (not shown in FIG. 14) corresponding to actuator 451 for movement of the touchscreen 452 relative to the display 453. A gap is provided between touchscreen 452 and display 453, so that the touchscreen 452 can be moved relative to display 453 without mechanical surface wear. The input device 450 is connected to a control (not shown) corresponding to the control 10. The touchscreen 452 can include a transparent support, including a touchscreen in a narrow sense, which is arranged on the support.

Flexible foamed element 460 to prevent penetration of dust particles between display 453 and touchscreen 452 is arranged between display 453 and touchscreen 452. For this purpose, the flexible foamed element 460 is arranged continuously on the edge of touchscreen 452. The flexible foamed element 460 has a rigidity adjusted to the weight of touchscreen 452, so that the touchscreen 452, in conjunction with the flexible foamed element 460, has a mechanical natural frequency between 5 Hz and 150 Hz in the movement direction (i.e., in the present practical example, in the direction of double arrow 480). Flexible foamed element 460 consists essentially of polyurethane.

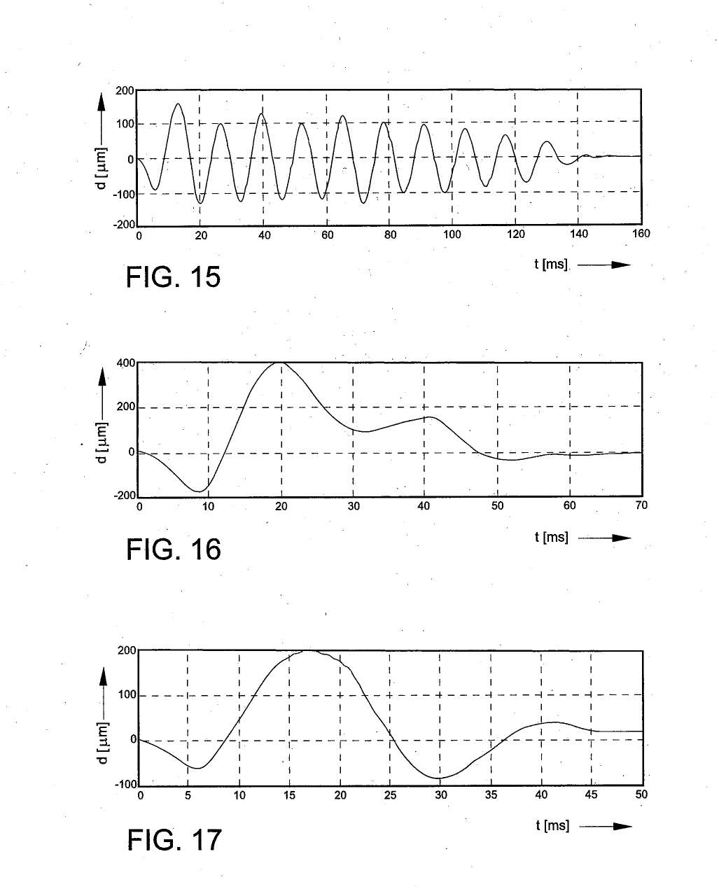

FIG. 15, FIG. 16 and FIG. 17 show practical examples of a deflection d of touchscreens 11, 70, 402, 452 in the direction of double arrows 65, 420 and 480 for implementation of tactile or haptic feedback. If, for example, an operating element 60, 61, 62, 63, 430, 470, 471, depicted by the display 12, 402, 452, is operated, the control 10 or a control corresponding to control 10 generates a control signal S to deflect touchscreens 11, 70, 402, 452 corresponding to a deflection d depicted in FIG. 15, FIG. 16 and FIG. 17.

The elements and spacings in FIGS. 2 to 14 are not necessarily drawn true to scale, considering simplicity and clarity. For example, the orders of magnitude of some elements and spacings in FIGS. 2 to 14 are exaggerated relative to other elements and spacings in FIGS. 2 to 14, in order to improve understanding of the practical examples of the present invention

### LIST OF REFERENCE NUMBERS

1 Vehicle
2 Steering wheel
3 Dashboard
4, 4A, 4B, 4C,
400, 450 Input device
10 Control
11, 70, 402, 452 Touchscreen
12, 72, 403, 453 Display
13, 84, 401 Actuator
15 Housing
16 Operating surface
17 Region
19 Lower part of a housing
20, 21 Opening
22, 23 Fastening element
24, 25, 26, 27, 31 Sleeve
30 Plug contact
40, 41, 50, 51, 79 Rod
42, 43, 52, 53 Sliding element
44, 45, 54, 55 Fastening element
46, 47, 56, 57 Sliding bearing
61, 62, 63, 430,
431, 470, 47 Operating element
65, 420, 480 Double arrow
70 Mount
73, 75 Control circuit board
74 Mount
76 Seal
77 Bolt
78 Interface board
80 Fastening element
81, 83 Screw
82 Frame
85 Eccentric
410 Flexible element
411, 412 Groove
413 Intersection site
414 Flat region
415, 415A,
415B, 415C Folded or protruding region
460 Flexible foamed element
A Display signal
d deflection
P Position signal
S Actuator control signal
t Time

1. An input device comprising:
a housing;
a display arranged in the housing for optical display of information, in which the housing is movable relative to the display;
a touchscreen arranged above the display for input of commands by touching an operating surface of the touchscreen; and
an actuator to move the touchscreen and housing in at least one direction.

2. An input device according to claim 1, wherein the touchscreen is fastened to the housing.

3. An input device according to claim 1, wherein the touchscreen is fastened outside of the housing.

4. An input device according to claim 3, wherein the housing includes a transparent region.

5. An input device according to claim 3, wherein the housing is transparent in the region of the touchscreen.

6. An input device according to claim 1, wherein the touchscreen is part of the housing.

7. An input device according to claim 1, wherein the touchscreen or the housing can be moved by the actuator relative to the display.

8. An input device according to claim 7, wherein the touchscreen or the housing is movable relative to the display only along a straight line.

9. An input device according to claim 8, wherein the touchscreen or the housing is movable parallel to an operating surface of the touchscreen.

10. An input device according to claim 1, wherein the touchscreen or the housing is movable relative to the display only along a straight line.

11. An input device according to claim 10, wherein the touchscreen or the housing is movable parallel to an operating surface of the touchscreen.

12. An input device according to claim 1, wherein the touchscreen or the housing is movable relative to the display only with one degree of freedom.

13. An input device according to claim 1, further comprising:
a connection element for shape-mated connection of the housing to the display, so that the housing can be moved relative to the display only along a straight line.

14. An input device according to claim 13, wherein the connection element includes a rod or a guide element.

15. An input device according to claim 14, wherein the housing and the display are movable along the rod relative to each other, parallel to an operating surface of the touchscreen.

16. An input device according to claim 1, wherein the housing has at least one opening covered by a flexible sleeve.

17. An input device according to claim 16, wherein the display has a fastening element guided through the opening for fastening of the display.

18. An input device comprising:
a housing;
a display arranged in the housing for optical display of information, in which the display can be moved only along a straight line in the housing; and
a touchscreen arranged above the display for input of commands by touching an operating surface of the touchscreen.

19. An input device according to claim 18 further comprising:
a connection element for shape-mated connection of the housing to the display, so that the housing can be moved relative to the display only along a straight line.

20. An input device according to claim 19, wherein the connection element includes a rod or a guide element 21.

21. An input device according to claim 20, wherein the housing and display are movable along the rod relative to each other, parallel to an operating surface of the touchscreen.

22. An input device according to claim 18, wherein the touchscreen is fastened to the housing or is part of the housing.

23. An input device according to claim 18, wherein the touchscreen is fastened outside of the housing.

24. An input device according to claim 18, wherein the housing includes a transparent region.

25. An input device according to claim 23, wherein the housing is transparent in the region of the touchscreen.

26. An input device according to claim 18, wherein the housing has at least one opening covered by a flexible sleeve.

27. An input device according to claim 26, wherein the display has a fastening element guided through the opening for fastening of the display.

28. An input device comprising:
a housing;
a display arranged in the housing for optical display of information;
a touchscreen arranged above the display for input of the commands by touching an operating surface of the touchscreen;
at least two guide elements arranged parallel to each other; and
at least two sliding elements for sliding along a guide element.

29. A vehicle comprising:
a steering wheel;
a dashboard;
a housing, a display arranged in the housing for optical display of information, in which the housing is movable relative to the display, and in which the display is fastened relative to the steering wheel or relative to the dashboard;
a touchscreen arranged above the display for input of commands by touching an operating surface of the touchscreen; and
an actuator to move the touchscreen of the housing in at least one direction.

30. A vehicle according to claim 29, wherein the actuator is connected to the steering wheel or the dashboard.

31. A vehicle according to claim 29, wherein the touchscreen is fastened to the housing.

32. A vehicle according to claim 29, wherein the touchscreen is fastened outside of the housing.

33. A vehicle according to claim 32, wherein the housing includes a transparent region.

34. A vehicle according to claim 33, wherein the housing is transparent in the region of the touchscreen.

35. A vehicle according to claim 29, wherein the touchscreen is part of the housing.

36. A vehicle according to claim 29, wherein the touchscreen or the housing is movable by means of an actuator relative to the display.

37. A vehicle according to claim 36, wherein the touchscreen or the housing is movable relative to the display only along a straight line.

38. A vehicle according to claim 37, wherein the touchscreen or the housing is movable parallel to an operating surface of the touchscreen.

39. A vehicle according to claim 29, wherein the touchscreen or the housing is movable relative to the display only along a straight line.

40. A vehicle according to claim 39, wherein the touchscreen or the housing is movable parallel to an operating surface of the touchscreen.

41. A vehicle according to claim 29, wherein the touchscreen or the housing is movable relative to the display only with one degree of freedom.

42. A vehicle according to claim 29, further comprising:
a connection element for shape-mated connection of the housing to the display, so that the housing can be moved relative to the display only along a straight line.

43. A vehicle according to claim 42, wherein the connection element includes a rod or guide element.

44. A vehicle according to claim 43, wherein the housing and the display are movable along the rod relative to each other, parallel to an operating surface of the touchscreen.

45. A vehicle according to claim 29, wherein the housing has at least one opening covered by a flexible sleeve.

46. A vehicle according to claim 45, wherein the display has a fastening element guided through the opening for fastening of the display to a steering wheel or the dashboard.

47. An input device comprising:
a display for optical display of information;
a transparent touchscreen arranged above the display for input of commands by touching an operating surface of the touchscreen;
a flexible element arranged between the display and the touchscreen to prevent penetration of particles between the display and the touchscreen, in which the flexible element has a rigidity adjusted to a weight of the touchscreen, so that the touchscreen, in conjunction with the flexible element, has a mechanical natural frequency between 5 Hz and 150 Hz; and
an actuator to move the touchscreen relative to the display in at least one direction.

48. An input device according to claim 47, wherein the flexible element is arranged on the edge of the touchscreen, so that it does not cover the display surface of the display.

49. An input device according to claim 47, wherein the flexible element is configured as a continuous seal or part of a continuous seal to seal a gap between the touchscreen and the display.

50. An input device comprising:
a display for optical display of information;
a touchscreen arranged above the display for input of commands by touching an operating surface of the touchscreen;
a flexible foam element arranged between the display and the touchscreen to prevent penetration of particles between the display and the touchscreen; and
an actuator to move the touchscreen relative to the display in at least one direction.

51. An input device according to claim 50, wherein the flexible element is arranged on the edge of the touchscreen, so that it essentially does not cover a display surface of the display.

52. An input device according to claim 50, wherein the flexible foamed element has a rigidity adjusted to the weight of the touchscreen, so that the touchscreen, in connection with the flexible element, has a mechanical natural frequency between 5 Hz and 150 Hz.

53. An input device according to claim 50, wherein the flexible element includes polyurethane.

54. An input device according to claim 50, wherein the flexible element essentially consists of polyurethane.

55. An input device according to claim 50, wherein the flexible element is configured as a continuous seal or part of a continuous seal to seal a gap between the touchscreen and the display.

56. An input device comprising:
a display for optical display of information;
a touchscreen arranged above the display for input of commands by touching an operating surface of the touchscreen;
a flexible element arranged between the display and the touchscreen with at least one pair of intersecting grooves; and
an actuator to move the touchscreen relative to the display in at least one direction.

57. An input device according to claim 56, wherein the grooves are sloped relative to the operating surface of the touchscreen between about 30° and about 60°.

58. An input device according to claim 56, wherein the grooves are sloped relative to the operating surface of the touchscreen by about 45°.

59. An input device according to claim 56, wherein at least two grooves have a common intersection site, configured as a spherically bulged dome.

60. An input device according to claim 56, wherein a transition between a groove and a flat region has a radius of curvature that is three to five times the thickness of a material, from which the groove is formed.

61. An input device according to claim 56, wherein the flexible element is configured to prevent penetration of particles between the display and the touchscreen.

62. An input device according to claim 56, wherein the flexible element has a rigidity that is adjusted to the weight of the touchscreen, so that the touchscreen, in connection with the flexible element, has a mechanical natural frequency between 5 Hz and 150 Hz.

63. An input device according to claim 56, wherein the flexible element is arranged on the edge of the touchscreen, so that it essentially does not cover the display surface of the display.

64. An input device according to claim 56, wherein the flexible element is configured as a continuous seal or as part of a continuous seal to seal a gap between the touchscreen and the display.

65. An input device according to claim 56, wherein the flexible element includes an elastomer.

66. An input device according to claim 56, wherein the flexible elements consists essentially of an elastomer.

67. An input device according to claim 56, wherein the flexible element includes a folded or protruding region, perpendicular to the movement direction.
